(19) United States
(12) Patent Application Publication
(10) Pub. No.: US 2013/0252342 A1
(43) Pub. Date: Sep. 26, 2013

(54) Detection And Quantification Of Vitamin D Metabolites Using An Alkylamine To Form Stable Adducts For Mass Spectrometric Analysis

(71) Applicants: Lisa J. Calton, Stockport (GB); Billy J. Molloy, Stockport (GB)

(72) Inventors: Lisa J. Calton, Stockport (GB); Billy J. Molloy, Stockport (GB)

(73) Assignee: MICROMASS UK LIMITED, Manchester (GB)

(21) Appl. No.: 13/703,916

(22) PCT Filed: Mar. 29, 2011
(86) PCT No.: PCT/GB11/50628

§ 371 Date: May 1, 2013

Related U.S. Application Data
(60) Provisional application No. 61/365,030, filed on Jul. 16, 2010.

(30) Foreign Application Priority Data
Jun. 30, 2010 (GB) 1011119.3

(51) Int. Cl. G01N 27/62

(52) U.S. Cl. CPC G01N 27/62
USPC 436/131

(57) ABSTRACT

The invention describes a method of determining the amount of an analyte in a sample wherein the analyte comprises one or more vitamin D metabolites; comprising the steps of; contacting the analyte with an alkylamine to form an alkylamine adduct; subjecting the adduct to a MS technique to determine the amount of the adduct; and calculating the amount of the analyte equivalent to the amount of the adduct.

The present invention relates to detection and quantification of vitamin D metabolites particularly to a method for enhancing the signal detected when mono, di or tri-hydroxy metabolites of vitamins D3 and D2 are analysed by mass spectrometry.

Vitamin D is a generic designation for a group of fat-soluble structurally similar sterols. Vitamin D compounds are derived from dietary ergocalciferol (from plants, vitamin D2) or cholecalciferol (from animals, vitamin D3), or by conversion of 7-dihydrocholesterol to vitamin D3 in the skin upon UV-exposure. Vitamin D2 and D3 are subsequently 25-hydroxylated in the liver to form 25-hydroxyvitamin D2 (25OHD2) and 25-hydroxyvitamin D3 (25OHD3). 25OHD2 and 25OHD3 represent the main body reservoir and transport form of vitamin D. They are stored in adipose tissue or are tightly bound by a transport protein while in circulation, and are subsequently hydroxylated to the corresponding 1,25-dihydroxy forms in the kidney. 1,25-dihydroxyvitamin D2 (DHVD2) and 1,25-dihydroxyvitamin D3 (DHVD3) are potent calciotropic hormones involved in the regulation of both calcium and phosphate metabolism, and are inhibitors of parathyroid hormone (PTH).

Vitamin D laboratory testing has increased significantly during the last decade because of an increasing awareness that vitamin D deficiency is very common and can increase fracture and, possibly, cancer risk. Measurement of total 25-hydroxyvitamin D (25OHD; sum of 25OHD2 and 25OHD3) is the preferred test for assessing vitamin D status, because it has a long serum half-life and its concentration is considered to be in equilibrium with vitamin D body stores.

Unfortunately, there are substantial discrepancies between test results obtained with different 25OHD assays. Most 25-OHD assays are competitive immunoassays or competitive assays based on vitamin D binding proteins. For such assays, 25OHD is a difficult analyte because of its hydrophobicity and relatively low serum concentrations. This often necessitates sample extraction and concentration before analysis, potentially increasing assay variability. Furthermore, equal detection of 25OHD2 and 25OHD3 represents a challenge, in particular for assays based on vitamin D binding protein, because binding proteins from many species show higher affinity for 25OHD3 than for 25OHD2. As a consequence of all these factors, only 50-60% of the approximately 100 laboratories that participate in the international quality assessment scheme for vitamin D metabolites (DEQAS), meet performance criteria consistently, and the results obtained for the same sample can differ up to 2- to 4-fold, sometimes even for the same assay, when performed in different laboratories.

It is known from WO 2010/019566 that methods can be used to measure the levels of DHVD2, DHVD3, or both (total DHVD) in a sample. For example, DHVD2 and DHVD3 can be selectively and sensitively detected and quantitated using methods employing affinity purification, analyte derivatization, and mass spectrometric (MS) techniques. WO 2010/019566 discloses that the combination of the affinity purification and analyte derivatization steps eliminates sample interferences, provides increased sensitivities, and provides more accurate results than methods that employ only analyte derivatization and concludes that the disclosed methods can facilitate reliable quantification of both DHVD2 and DHVD3 to 5 pg/mL or lower. The materials and methods are said to be useful to aid in the diagnosis of vitamin D deficiencies or hypervitaminosis D, to monitor vitamin D replacement therapies, and to aid in the diagnosis of various disorders, e.g., hypercalcemia, chronic renal failure, hypoparathyroidism, sarcoidosis, granulomatous diseases, malignancies, primary hyperparathyroidism, and physiologic hyperarathyroidism.

According to the present invention there is provided a method of determining the amount of an analyte in a sample wherein the analyte comprises one or more vitamin D metabolites; comprising the steps of;

contacting the analyte with an alkylamine to form an alkylamine adduct;

subjecting the adduct to a MS technique to determine the amount of the adduct; and.

calculating the amount of the analyte equivalent to the amount of the adduct.

The vitamin D metabolite preferably comprises one or more compounds selected from the group consisting of:

1-alpha-hydroxyvitamin D2, 1-alpha-hydroxyvitamin D3, 25-hydroxyvitamin D2, 25-hydroxyvitamin D3, 1,25-dihydroxyvitamin D2, 1,25-dihydroxyvitamin D3, (R) 24, 25-dihydroxyvitamin D2, (R)24,25 dihydroxyvitamin D3,(S) 24,25-dihydroxyvitamin D2, (S)24,25 dihydroxyvitamin D3, 1,24,25-trihydroxyvitamin D2, and 1,24,25-trihydroxyvitamin D3.

Mixtures of two or more of these metabolites may be detected and quantified by the method of this invention.

The amine may be a monoamine or a diamine.

Use of a monoamine is preferred, especially a straight chain saturated alkylamine. Preferred alkylamines comprise C₄₋C₁₂, preferably C₄-C₈, more preferably C₆₋C₈ alkylamines. Use of hexylamine or octylamine are especially preferred.

Diamines which may be employed have the formula H₂N(CH₂)ₙNH₂ wherein n is an integer from 2-12, preferably an even integer from 2-12.

The alkylamine may be added to the liquid sample followed by the step of UPLC/HPLC separation of the sample.

Alternatively the alkylamine may be added to the liquid chromatography flow prior to MS detection.

In a further possibility the alkylamine may added to the sample pre or post extraction.

The sample may be a dried extracted sample. In this case the method may include the step of adding the dried extracted sample to a solution containing the alkylamine.

The MS technique preferably comprises a tandem (MS/MS) technique. Use of an LC-MS/MS technique is especially preferred. The MS technique may comprise a triple quadrapole technique wherein Multiple Reaction Monitoring (MRM) in positive ion mode is employed. The LC-MS/MS technique may comprise a Q1 scan tuned to detect a precursor that corresponds to the analyte-amine adduct. For example for detection of 1,25-dihydroxyvitamin D3. The Q1 peak may comprise MRM 518.6/102.1 when hexylamine is used and 546.6/130.2 when octylamine is used to form the adduct.

The invention is further described by means of example but not in any limitative sense with reference to the accompanying drawings of which;

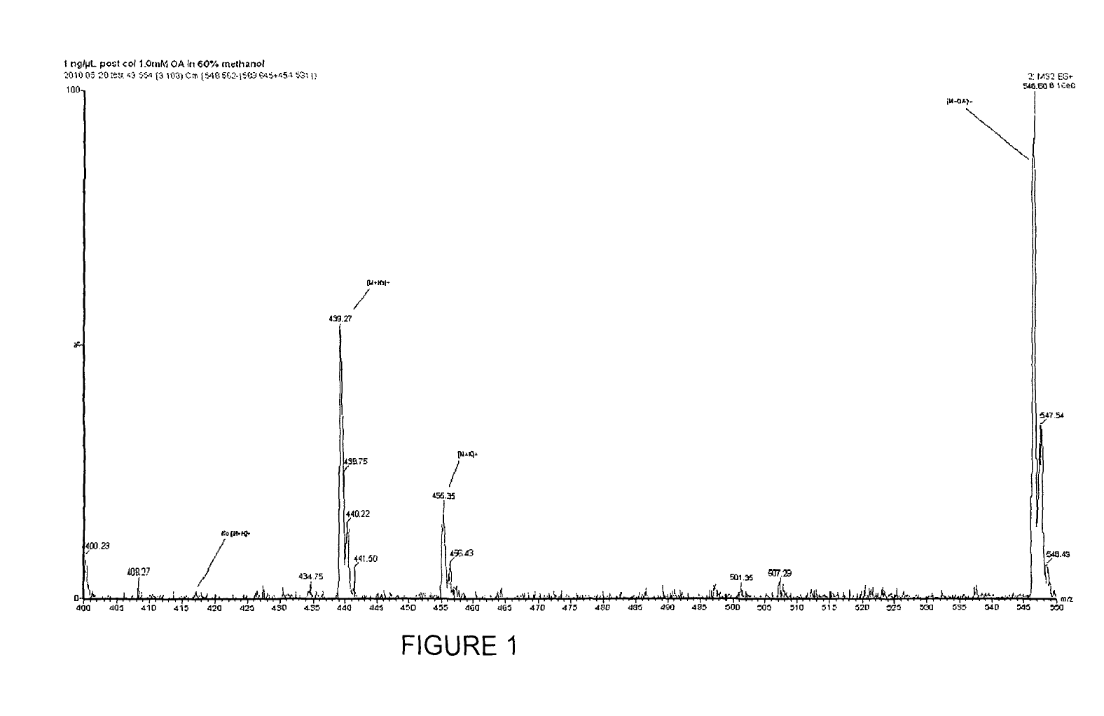

FIG. 1 is a full scan spectrum of the chromatographic peak for 1,25-dihydroxyvitamin D3 when octylamine is introduced post-column;

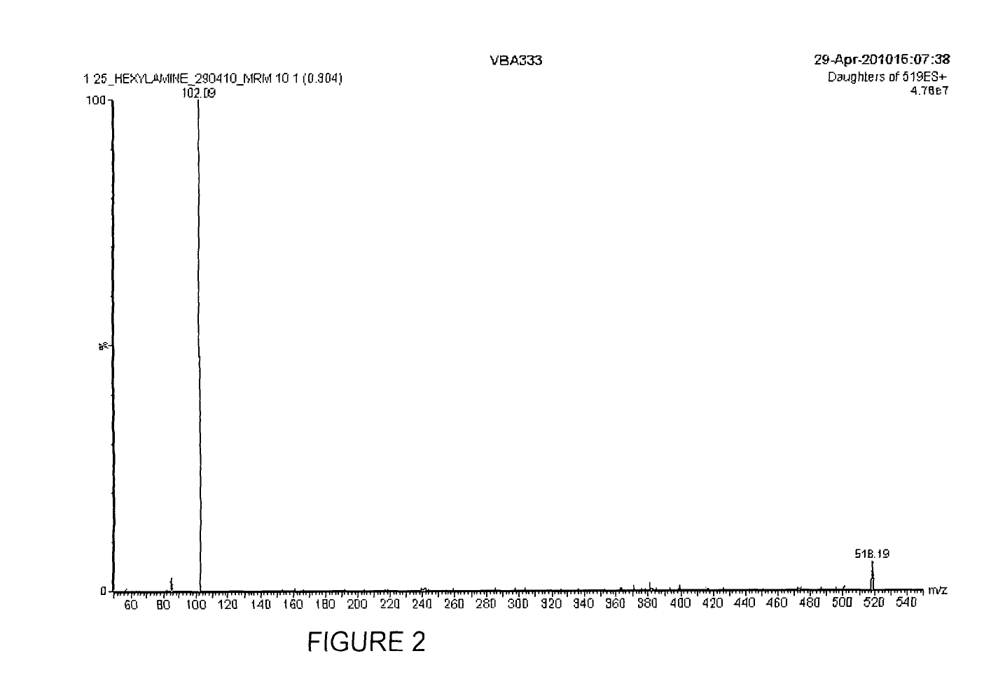

FIG. 2 is the MRM spectrum of the hexylamine adduct of 1,25-dihydroxyvitamin D3 at a collision energy of 10 eV;

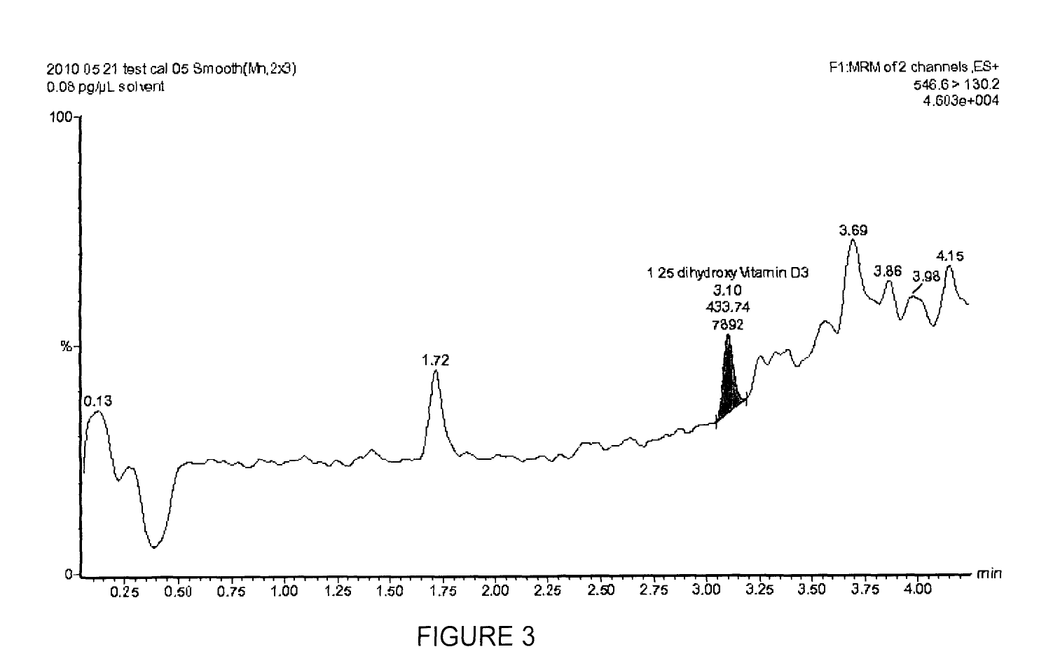

FIG. 3 is a chromatogram demonstrating assay of 1,25-dihydroxyvitamin D3, and

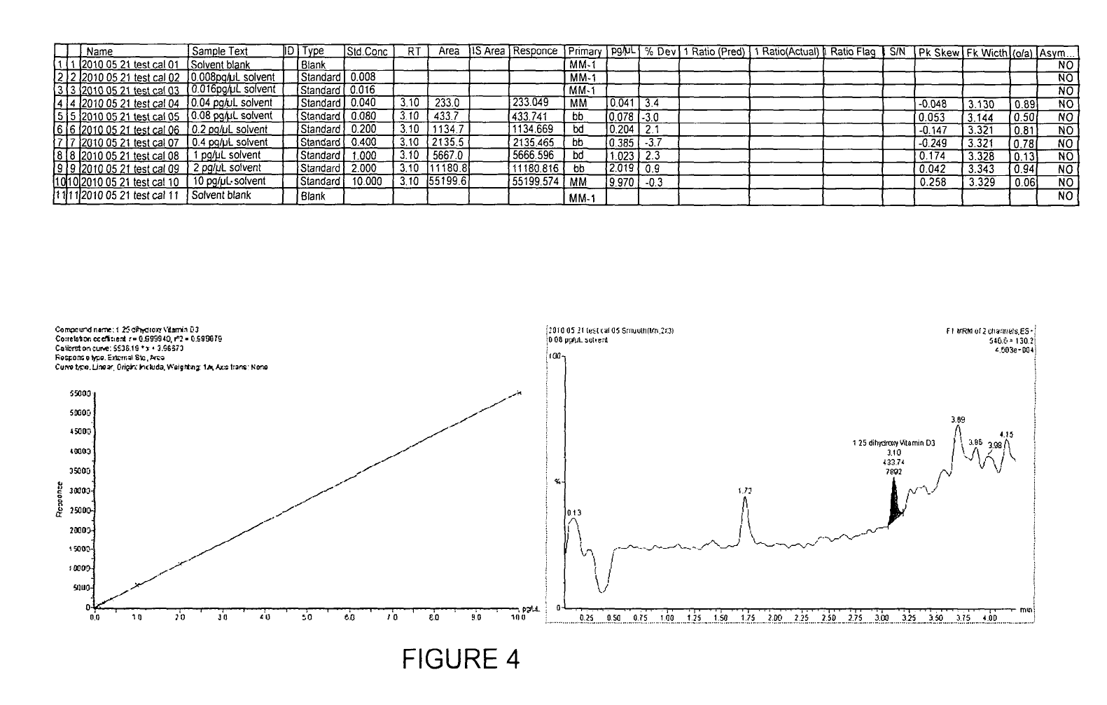

FIG. 4 is a graph showing linearity for the formation of the octylamine adduct of 1,25-dihydroxyvitamin D3.

Liquid chromatography was carried out using two sets of parameters.

### Method 1

Mobile phase A: Water with 0.05% formic acid
Mobile phase B: MeOH with 0.05% formic acid
Weak wash solvent: Water
Strong wash solvent: ACN
Column: ACQUITY BEH 2.1×50 mm C18
Column temp: 40° C.
Injection Vol: 20 μL (Full Loop)
Flow Rate: 0.35 ml/min

Gradient:
Run time: 4.6 mins

| Time | % A | % B | curve |
|---|---|---|---|
| 0 | 40 | 60 | 1 |
| 4 | 2 | 98 | 6 |
| 4.1 | 2 | 98 | 6 |
| 4.2 | 40 | 60 | 6 |
| 4.5 | 40 | 60 | 6 |

Various concentrations (0.1-2 mM of octylamine in 60% methanol (aqueous) were infused, post-column, using the fluidics system to produce adducts.

### Method 2

Mobile phase A: Water with 0.1% formic acid and 0.1 mM hexylamine
Mobile phase B: MeOH with 0.1% formic acid and 0.1 mM hexylamine
Weak wash solvent—Mobile Phase A
Strong wash solvent: Mobile Phase B
Column: ACQUITY UPLC BEH Shield RP18 2.1×50 mm
Column temp: 75° C.
Injection Vol: 50 μL (Full Loop)
Flow Rate: 0.5 mL/min

Gradient:
Run time: 3 mins

| Time | % A | % B | curve |
|---|---|---|---|
| 0 | 50 | 50 | 1 |
| 0.2 | 50 | 50 | 6 |
| 2.0 | 0 | 100 | 6 |
| 2.8 | 50 | 50 | 6 |

Mass spectrometry was carried out using the following conditions:
The instrument was tuned for unit resolution for MS1 (0.7 Da FWHM) and the resolution for MS2 (0.8-0.9 Da FWHM).

### MS Conditions

| Polarity | ES+ |
|---|---|
| Capillary (kV) | 3.0 |
| Cone (V) | 20.0 |
| Extractor (V) | 3.00 |
| RF (V) | 0.1 |
| Source Temperature (° C.) | 120 |
| Desolvation Temperature (° C.) | 350 |
| Cone Gas Flow (L/Hr) | 20 |
| Desolvation Gas Flow (L/Hr) | 1000 |
| Collision Gas Flow (ml/min) | 0.15 |

### MRM Transitions

| | | | Cone | Collision- |
|---|---|---|---|---|
| | | Dwell | Voltage | Energy |
| Compound | MRM | (secs) | (V) | (eV) |
| [1,25diOHD3 + HA]⁺ | 518.6 > 102.1 | 0.08 | 20 | 28 |
| [1,25diOHD3 + OA]⁺ | 546.6 > 130.2 | 0.08 | 20 | 10 |

Samples were prepared as follows:

1,25diOHD3, 1,25diOHD2, (R)24,25diOHD3 and (S)24,25diOHD3 were purchased from Sigma-Aldrich and were each dissolved in ethanol to produce 2 mg/mL, 2 mg/mL, 0.5 mg/mL and 1 mg/mL standards respectively. These solutions were kept in the freezer until required. Solutions were prepared at various concentrations from the primary stocks by diluting with 60% methanol (aqueous). Hexylamine (MW 101.2) and octylamine (MW 129.2) were purchased from Sigma-Aldrich. Solutions were prepared at various concentrations by dilution with 60% aqueous methanol.

Full scan data was acquired simultaneously with the MRM date using Method 1, infusing oxylamine post-column. The spectrum in FIG. 2 was extracted from the full scan data at the retention time of 1,25diOHD3.

A full scan spectrum of chromatographic peak for 1 μg/mL solvent standard injection of 1,25di OHD3 when octylamine is introduced post-column. [M+OA]⁺ (m/z+546.6) was observed to be the most abundant ion.

1,25diOHD has been found to form a sodium adduct [M+OA]^{+.} This causes lowering of the sensitivity for the assay significantly due to a difficulty in fragmenting this species to form product ions in the collision cell of the mass spectrometer. Addition of octylamine (OA) resulted in the dominant precursor ion being the [M+OA]⁺ adduct. Protonated species were not observed. By adjustment of the concentration of alkylamine the levels of sodium adducts were reduced. The alkylamine adduct was observed to readily dissociate in the collision cell of the mass spectrometer to form a protonated alkylamine ion as the dominant or only product ion (m/z=102). This is shown in FIG. 1. An enhancement in sensitivity in relation to other analytical methods was therefore obtained.

It is an advantage of this invention that the concentration of alkylamine required to form an adduct may be very low. A concentration of 0.1 mM of hexylamine added to the mobile phase resulted in the dominant precursor ion being the hexylamine adduct with protonated species not being observed.

FIG. 3 shows a chromatogram demonstrating the possibility of reaching the low limits of detection required for this assay.

FIG. 4 shows the alkylamine adduct formation for 1,25diOHD3 to be linear over the concentration range 40-10,000 pg/mL.

1. A method of determining the amount of an analyte in a sample wherein the analyte comprises one or more vitamin D metabolites, comprising the steps of:
contacting the analyte with an alkylamine to form an alkylamine adduct;
subjecting the adduct to a MS technique to determine the amount of the adduct; and
calculating the amount of the analyte equivalent to the amount of the adduct.

2. The method of claim 1, wherein the vitamin D metabolite comprises one or more compounds selected from the group consisting of:
1-alpha-hydroxy vitamin D2, 1-alpha-hydroxy vitamin D3, 25-hydroxy vitamin D2, 25-hydroxyvitamin D3, 1,25-dihydroxyvitamin D2, 1,25-dihydroxyvitamin D3, (R) 24,25-dihydroxyvitamin D2, (R)24,25 dihydroxyvitamin D3, (S)24,25-dihydroxyvitamin D2, (S)24,25 dihydroxyvitamin D3, 1,24,25-trihydroxyvitamin D2, and 1,24,25-trihydroxyvitamin D3.

3. The method of claim 1, wherein the amine is a monoamine.

4. The method of claim 1, wherein the amine is a C₄-C₁₂ alkylamine.

5. The method of claim 1, wherein the amine is a C₄-C₈ alkylamine.

6. The method of claim 1, wherein the amine is a C₆-C₈ alkylamine.

7. The method of claim 1, wherein the amine is a diamine of formula H₂N(CH2)nNH2 wherein n is an integer from 2-12.

8. The method of claim 1, wherein the MS technique comprises a tandem (MS/MS) technique.

9. The method of claim 1, wherein the MS technique is a LC-MS/MS technique.

10. The method of claim 1, wherein the MS technique comprises a triple quadruple technique using Multiple Reaction Monitoring (MRM) in positive ion mode.

11. The method of claim 1, wherein the LC-MS/MS technique comprises a Q1 scan to detect a precursor corresponding to the analyte-amine adduct.

12. The method of claim 1, wherein the amine is a diamine.
